(19) United States
(12) Patent Application Publication
(10) Pub. No.: US 2026/0046586 A1
(43) Pub. Date: Feb. 12, 2026

(54) DIRECTIONAL SOUND CONTROL METHOD AND DEVICE

(71) Applicant: Lenovo (Beijing) Limited, Beijing (CN)

(72) Inventors: Yang LIU, Beijing (CN); Xianshuan ZENG, Beijing (CN)

(21) Appl. No.: 19/297,743

(22) Filed: Aug. 12, 2025

(30) Foreign Application Priority Data
Aug. 12, 2024 (CN) 202411102996.7

(51) Int. Cl. H04S 7/00; H04S 3/00

(52) U.S. Cl. CPC H04S 7/303; H04S 3/008; H04S 2400/01; H04S 2400/11

(57) ABSTRACT

A directional sound control method, applied to an electronic device, includes determining a target position of a user relative to a sound panel, based on the target position, determining a first group of sound-emitting areas and a second group of sound-emitting areas from a plurality of sound-emitting areas of the sound panel, and controlling sound-emitting areas in the first group of sound-emitting areas and sound-emitting areas in the second group of sound-emitting areas to output an audio signal. The sound-emitting areas are arranged longitudinally along the sound panel. The plurality of sound-emitting areas are arranged sequentially in parallel. The first group of sound-emitting areas and the second group of sound-emitting areas are located on two sides of and adjacent to the target position. Each of the first group of sound-emitting areas and the second group of sound-emitting areas includes at least one sound-emitting area.

### CROSS-REFERENCES TO RELATED APPLICATION

The present application claims priority to Chinese Patent Application No. 202411102996.7 filed on Aug. 12, 2024, the entire content of which is incorporated herein by reference.

### FIELD OF TECHNOLOGY

The present disclosure relates to the control technology field and, more particularly, to a directional sound control method and a directional sound control apparatus.

### BACKGROUND

Directional sound technology is widely applied. When an electronic device supports directional sound emission, the electronic device controls a corresponding sound channel in a sound panel to emit sound according to a position of a user in front of the sound panel. Thus, tracking of a sound broadcast wave is realized to allow the user to hear the sound properly when moving. However, when the user is not in the center area of the sound panel, the sound channel cannot be appropriately controlled to emit sound. Thus, a large difference exists in the left and right ears of the user, which prevents the user from hearing the sound properly.

### SUMMARY

One aspect of this disclosure provides a directional sound control method applied to an electronic device. The method includes determining a target position of a user relative to a sound panel, based on the target position, determining a first group of sound-emitting areas and a second group of sound-emitting areas from a plurality of sound-emitting areas of the sound panel, and controlling sound-emitting areas in the first group of sound-emitting areas and sound-emitting areas in the second group of sound-emitting areas to output an audio signal. The sound-emitting areas are arranged longitudinally along the sound panel. The plurality of sound-emitting areas are arranged sequentially in parallel. The first group of sound-emitting areas and the second group of sound-emitting areas are located on two sides of and adjacent to the target position. Each of the first group of sound-emitting areas and the second group of sound-emitting areas includes at least one sound-emitting area. A number of sound-emitting areas in the first group of sound-emitting areas and a number of sound-emitting areas in the second group of sound-emitting areas are the same. When the target position is different, the number of sound-emitting areas determined in the first group of sound-emitting areas is not exactly the same.

Another aspect of this disclosure provides a directional sound control apparatus, applied to an electronic device, including a position determination unit, a sound group determination unit, and a directional sound control unit. The position determination unit is configured to determine a target position of a user relative to a sound panel. The sound group determination unit is configured to determine a first group of sound-emitting areas and a second group of sound-emitting areas from a plurality of sound-emitting areas of the sound panel based on the target position. The sound-emitting areas are arranged longitudinally along the sound panel. The plurality of sound-emitting areas are arranged sequentially in parallel. The first group of sound-emitting areas and the second group of sound-emitting areas are located on two sides of and adjacent to the target position. Each of the first group of sound-emitting areas and the second group of sound-emitting areas includes at least one sound-emitting area. A number of sound-emitting areas in the first group of sound-emitting areas and a number of sound-emitting areas in the second group of sound-emitting areas are the same. When the target position is different, the number of sound-emitting areas determined in the first group of sound-emitting areas is not exactly the same. The directional sound control unit is configured to control sound-emitting areas in the first group of sound-emitting areas and sound-emitting areas in the second group of sound-emitting areas to output an audio signal.

Another aspect of this disclosure provides an electronic device, including one or more processors and one or more memories. The one or more memories store computer instructions that, when executed by the one or more processors, cause the one or more processors to determine a target position of a user relative to a sound panel, based on the target position, determine a first group of sound-emitting areas and a second group of sound-emitting areas from a plurality of sound-emitting areas of the sound panel, and control sound-emitting areas in the first group of sound-emitting areas and sound-emitting areas in the second group of sound-emitting areas to output an audio signal. The sound-emitting areas are arranged longitudinally along the sound panel. The plurality of sound-emitting areas are arranged sequentially in parallel. The first group of sound-emitting areas and the second group of sound-emitting areas are located on two sides of and adjacent to the target position. Each of the first group of sound-emitting areas and the second group of sound-emitting areas includes at least one sound-emitting area. A number of sound-emitting areas in the first group of sound-emitting areas and a number of sound-emitting areas in the second group of sound-emitting areas are the same. When the target position is different, the number of sound-emitting areas determined in the first group of sound-emitting areas is not the same.

### BRIEF DESCRIPTION OF THE DRAWINGS

In combination with accompanying drawings and with reference to the following description of embodiments, the above and other features, advantages, and aspects of the embodiments of the present disclosure will become more apparent. Throughout the drawings, a same or similar reference number represents a same or similar element. It should be understood that the drawings are schematic and that an element is not necessarily drawn to scale.

FIG. 1 is a schematic flowchart of a directional sound control method according to some embodiments of the present disclosure.

FIG. 2 is a schematic diagram showing a layout of a sounding area of a sound panel according to some embodiments of the present disclosure.

FIG. 3 is a schematic flowchart of another directional sound control method according to some embodiments of the present disclosure.

FIGS. 4 to 7 are schematic diagrams of two sounding area groups on two sides of a user when the user is at different target positions relative to a sound panel according to some embodiments of the present disclosure.

FIG. 8 is a schematic flowchart of another directional sound control method according to some embodiments of the present disclosure.

FIG. 9 is a schematic flowchart of determining a plurality of sounding areas of a sound panel according to some embodiments of the present disclosure.

FIG. 10 is a schematic diagram showing a layout of sounding areas with different widths divided in a display unit having a sound panel according to some embodiments of the present disclosure.

FIG. 11 is a schematic diagram showing widths and a layout of sounding channels with two different widths arranged in a screen when a screen size is 27 inches according to some embodiments of the present disclosure.

FIGS. 12 to 18 are schematic diagrams of a sounding area on the screen of FIG. 11 that needs to be started and output an audio when a user head is at different positions relative to the screen.

FIG. 19 is another schematic flowchart of determining a plurality of sounding areas in a sound panel according to some embodiments of the present disclosure.

FIG. 20 is a schematic structural diagram of each sounding area in a sound panel arranged on an upper layer of a display unit according to some embodiments of the present disclosure.

FIG. 21 is a schematic structural diagram of a directional sound control apparatus according to some embodiments of the present disclosure.

FIG. 22 is a schematic structural diagram of an electronic device according to some embodiments of the present disclosure.

### DETAILED DESCRIPTION

Embodiments of the present disclosure are described below in conjunction with the accompanying drawings of embodiments of the present disclosure. The terms used in embodiments of the present disclosure are only used to explain specific embodiments of the present disclosure, and are not intended to limit the present disclosure.

Embodiments of the present disclosure are described below in conjunction with the accompanying drawings. Those of ordinary skill in the art can understand that, with the development of technology and the emergence of new scenarios, the technical solutions of embodiments of the present disclosure are also applicable to similar technical problems.

The terms “first” and “second” in the specification and claims of the present disclosure and in the accompanying drawings are used to distinguish similar objects and are not necessarily used to describe a specific sequence or order. Such terms can be interchanged where appropriate, which is only a way of distinguishing objects with the same attribute in embodiments of the present disclosure during the description. In addition, the terms “comprising,” and “having,” and any variations thereof, are intended to cover a non-exclusive inclusion, such that a process, method, system, product, or device that includes a series of elements is not limited to those elements, but may include other elements not clearly listed or inherent to such process, method, product, or device.

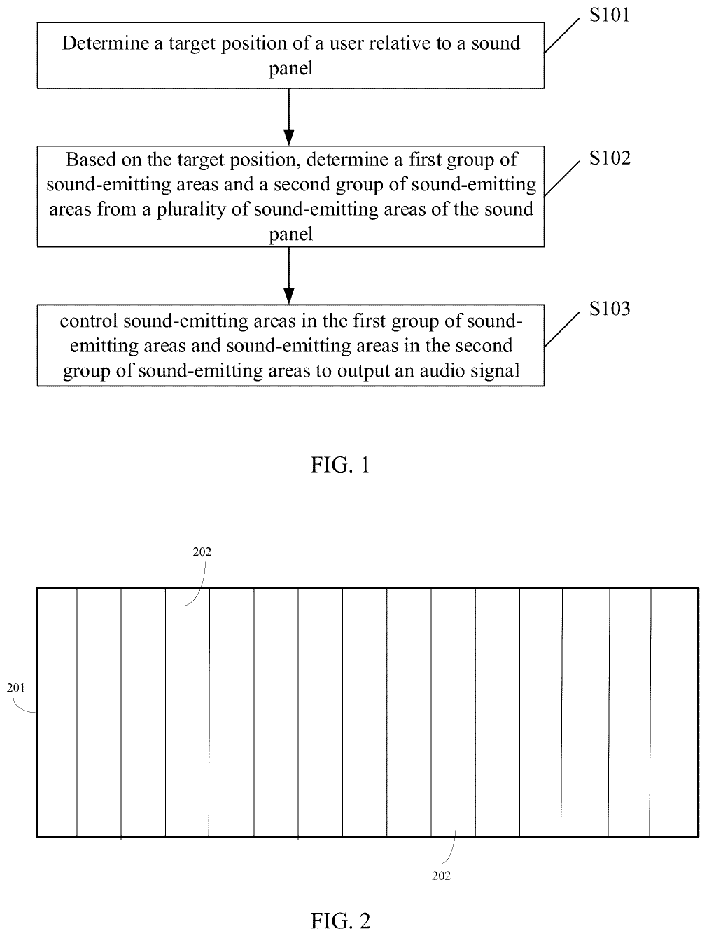

FIG. 1 is a schematic flowchart of a directional sound control method according to some embodiments of the present disclosure. The method of embodiments of the present disclosure can be applied to an electronic device. The electronic device can include a sound panel. The electronic device can control different sound-emitting areas of the sound panel to realize directional sound control. The method includes steps S101 to S103.

At S101, a target position of a user relative to the sound panel is determined.

The target position is a relative position of the user relative to the sound panel.

In the present disclosure, a plurality of implementations can be applied to determine the target position.

For example, in some embodiments, an image acquisition apparatus, such as a camera, can be provided on a side of the sound panel facing the user. By collecting a user image of the user in front of the sound panel through the image acquisition apparatus, the electronic device can determine the target position of the user relative to the sound panel based on the collected user image.

In some other embodiments, a radar detection apparatus can also be provided on the sound panel. The target position of the user relative to the sound panel can be detected based on the radar detection apparatus.

In the present disclosure, the sound panel can be a panel capable of propagating audio outward. To realize directional sound emission, the sound panel can include a plurality of sound-emitting areas. Each sound-emitting area can be a sound channel. The electronic device can independently control each sound-emitting area to output audio or not to output audio. For example, the sound-emitting area can include an electrode and a diaphragm. The electronic device can play audio outwardly by controlling the electrode of the sound area to be powered on and driving the diaphragm to vibrate.

The sound-emitting areas in the sound panel can be arranged along a longitudinal direction of the sound panel, and the plurality of sound-emitting areas can be arranged in parallel in sequence. When the directional sound emission control is realized based on the sound panel, the sound-emitting areas of the sound panel can be arranged in a vertical direction in sequence. Thus, when the user stands in front of the sound panel, the sound-emitting areas can be parallel to a standing direction of the user to allow the plurality of sound-emitting areas to be arranged on the left and right sides of the user.

For ease of understanding, FIG. 2 is a schematic diagram showing a layout of a sounding area of a sound panel according to some embodiments of the present disclosure. As shown in FIG. 2, the sound panel includes a plurality of sound-emitting areas 202. Each sound-emitting area is arranged along the longitudinal direction of the sound panel, and the plurality of sound-emitting areas are sequentially arranged along a transverse direction of the sound panel. The sound-emitting areas are independent of each other. Thus, the sound-emitting areas can be independently controlled.

In the present disclosure, the sound panel can have various possible forms, which are not limited here.

In some embodiments, to enable the electronic device to play audio directionally to the user according to the relative position of the user viewing the display image while the electronic device displays the image, in the present disclosure, the sound panel can be integrated into the display unit of the electronic device. For example, a transparent sound panel can be disposed on an outer layer of the display unit of the electronic device. The sound panel can include an electrode layer formed on the outer layer of the display unit, and a diaphragm covering the electrode layer. Based on this, the electronic device can control the electrode layer corresponding to each sound-emitting area to be powered on and vibrate to drive the diaphragm in the corresponding area of the sound-emitting area to vibrate.

For example, the display unit of the electronic device can be a sound-concentrating screen, and the sound panel can be the panel of the sound-concentrating screen. The sound-concentrating screen can be an innovative integration of the display and audio technology. A traditional speaker may not be needed, and the screen can be directly used as a sounding unit to realize the directional sound emission of the screen.

At S102, based on the target position, a first group of sound-emitting areas and a second group of sound-emitting areas are determined from the plurality of sound-emitting areas of the sound panel.

The first group of sound-emitting areas and the second group of sound-emitting areas can be arranged on two sides of the target position and close to the target position. The first group of sound-emitting areas and the second group of sound-emitting areas each can include at least one sound-emitting area. The first group of sound-emitting areas and the second group of sound-emitting areas can include the same number of sound-emitting areas.

In the present disclosure, to merely facilitate distinction, the sound-emitting area groups arranged on the two sides of the target position of the user relative to the sound panel can be referred to as the first group of sound-emitting areas and the second group of sound-emitting areas, respectively.

In the present disclosure, regardless of the target position of the user, the number of sound-emitting areas included in the two sound-emitting area groups that need to emit sound can be determined to be the same. When the target position of the user relative to the sound panel is different, the difference in the total number of sound-emitting areas arranged on both sides of the target position can also be different. Based on this, when the target position is different, the number of sound-emitting areas in the first group of sound-emitting areas cannot be determined to be exactly the same. Accordingly, when the target position is different, the number of sound-emitting areas in the second group of sound-emitting areas cannot be determined to be exactly the same.

For example, when the target position is located in the center area of the sound panel, since the number of sound-emitting areas on both sides of the target position is relatively large, the number of sound-emitting areas of the first group of sound-emitting areas and the second group of sound-emitting areas can be determined to be relatively large. When the target position of the user relative to the sound panel is at the edge of the sound panel, the number of sound-emitting areas on one side of the target position may be relatively small. To ensure the first group of sound-emitting areas and the second group of sound-emitting areas have the same number of sound-emitting areas, the number of sound-emitting areas of the first group of sound-emitting areas and the second group of sound-emitting areas can be relatively small.

At S103, the sound-emitting areas of the first group of sound-emitting areas and the second group of sound-emitting areas are controlled to output an audio signal.

For the specific implementation of controlling the sound-emitting areas of the sound-emitting area group to output an audio signal, reference can be made to the above description, which is not repeated here.

Based on the above, in the present disclosure, according to the target position of the user relative to the sound panel, two sound-emitting area groups located on both sides of the target position can be determined from the plurality of sound-emitting areas of the sound panel, and the two sound-emitting area groups can have the same number of sound-emitting areas. Therefore, no matter where the target position of the user relative to the sound panel is, in the present disclosure, the same number of sound-emitting areas on both sides of the user can be controlled to play the audio signal to reduce the sound pressure difference between the left and right ears of the user. Thus, the sound panel can be more appropriately controlled to emit sound directionally based on the position of the user.

Under the premise of satisfying the user's listening requirements, more sound-emitting areas that play the audio on both sides of the user may not be necessarily beneficial. Considering the power consumption, the number of sound-emitting areas of the sound-emitting area group can be appropriately controlled. Based on this, in the present disclosure, a target number can be preset. The target number can be the maximum number of sound-emitting areas that the set sound-emitting area group can have.

Based on this, to appropriately determine the first group of sound-emitting areas and the second group of sound-emitting areas, in the present disclosure, a center sound-emitting area corresponding to the user can be determined from the plurality of sound-emitting areas of the sound panel based on the target position. Then, according to the target number and the number of the sound-emitting areas on each of the two sides of the center sound-emitting area, the first group of sound-emitting areas and the second group of sound-emitting areas on the two sides of and close to the center sound-emitting area can be determined. The number of the sound-emitting areas in each of the first group of sound-emitting areas and the second group of sound-emitting areas may not exceed the target number.

The center sound-emitting area can be a sound-emitting area of the sound panel corresponding to the target position. Considering that the user body has a certain width, the relative position of the user relative to the sound panel can be a position area. Based on this, a sound-emitting area that covers the target position the most can be the center sound-emitting area. Of course, the center sound-emitting area can be determined in other methods, which are not limited here.

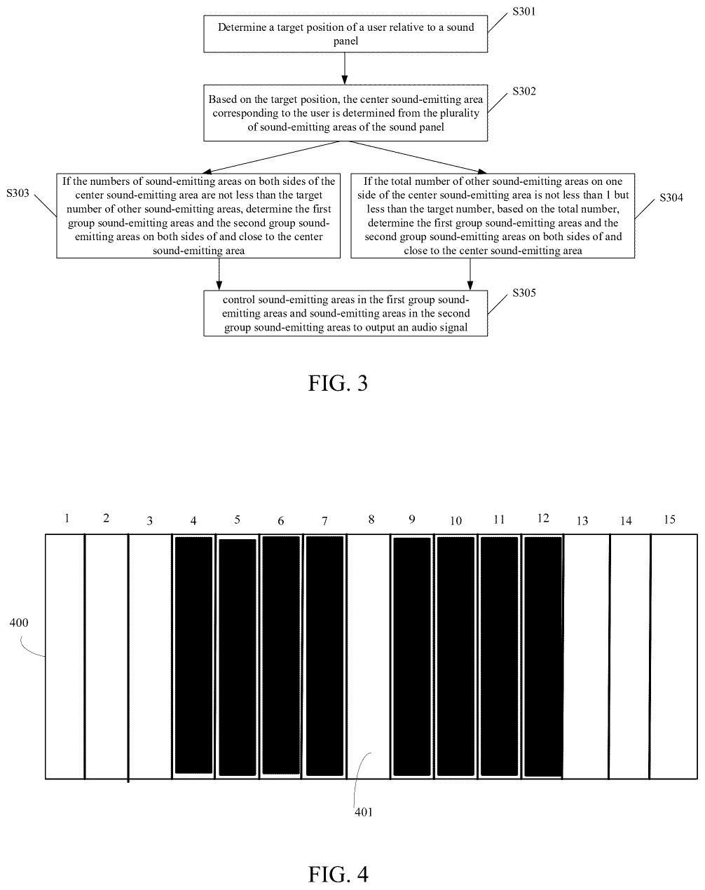

According to the target number and the numbers of the sound-emitting areas of the two sides of the center sound-emitting area, the first group of sound-emitting areas and the second group of sound-emitting areas can be determined, which is not limited. Example shown in FIG. 3 is described below. FIG. 3 is a schematic flowchart of another directional sound control method according to some embodiments of the present disclosure. The method includes the following processes.

At S301, the target position of the user relative to the sound panel is determined.

For this step, reference can be made to the above description, which is not repeated.

At S302, based on the target position, the center sound-emitting area corresponding to the user is determined from the plurality of sound-emitting areas of the sound panel.

For example, the center sound-emitting area is the sound-emitting area where the target position is located, or the sound-emitting area that covers the target position the most, which is not limited here.

At S303, if the number of sound-emitting areas on each of the two sides of the center sound-emitting area is not less than the target number of other sound-emitting areas, the first group of sound-emitting areas and the second group of sound-emitting areas on both sides of and close to the center sound-emitting area are determined.

The first group of sound-emitting areas and the second group of sound-emitting areas each can include the target number of sound-emitting areas.

For example, the target number can be 4. If more than or equal to 4 sound-emitting areas are provided on each of the two sides of the center sound-emitting area, four sound-emitting areas closest to the center sound-emitting area can be selected for each center sound-emitting area as a sound-emitting area group. Then, four sound-emitting areas can be provided on each side of the two sides of the user and configured to output the audio.

At S304, if the total number of other sound-emitting areas on one side of the center sound-emitting area is not less than 1 but less than the target number, based on the total number, the first group of sound-emitting areas and the second group of sound-emitting areas on both sides of and close to the center sound-emitting area are determined.

Each of the first sound-emitting area and the second sound-emitting area can include the total number of sound-emitting areas.

For example, the total number of other sound-emitting areas on one side of the center sound-emitting area can be less than the target number. If the sound-emitting areas that need to output sound are still selected based on the target number, the number of sound-emitting areas capable of emitting sound on the left and right sides of the center sound-emitting area can be inconsistent. Then, the sound pressure difference between the left and right ears of the user can increase. Based on this, in the present disclosure, the side corresponding to the center sound-emitting area with fewer sound-emitting areas can be determined. The number of sound-emitting areas on the side with fewer sound-emitting areas can be used as the number of sound-emitting areas included in each sound-emitting area group on each of the two sides of the center sound-emitting area.

In connection with FIGS. 4 to 7, examples are described below.

FIGS. 4 to 7 are schematic diagrams of two sounding area groups on two sides of a user when the user is at different target positions relative to a sound panel according to some embodiments of the present disclosure.

As shown in FIGS. 4 to 7, for example, the maximum number of sound-emitting areas in a sound-emitting area group is 4. That is, the target number is 4. Moreover, As shown in FIGS. 4 to 7, for example, the sound panel includes 15 sound-emitting areas. As shown in FIGS. 4 to 7, to show the sound-emitting areas belonging to the sound-emitting area group, the sound-emitting areas belonging to the sound-emitting area group are marked in black.

As shown in FIGS. 4 to 7, the sound panel 400 includes a plurality of sound-emitting areas. Each sound-emitting area is a vertical strip. Each sound-emitting area is arranged along the longitudinal direction of the sound panel, and the plurality of sound-emitting areas are sequentially arranged. To facilitate distinguishing the 15 sound-emitting areas, the 15 sound-emitting areas are sequentially numbered in FIGS. 4 to 7. As shown in FIGS. 4 to 7, from left to right, the plurality of sound-emitting areas are sequentially numbered 1 to 15.

As shown in FIG. 4, the user is located in the center position area of the sound panel. The target position of the user relative to the sound panel is located in the middle sound-emitting area among the 15 sound-emitting areas. As shown in FIG. 4, the 8th sound-emitting area from the left to the right is the center sound-emitting area 401 corresponding to the target position. Based on this, since not less than 4 (target number) sound-emitting areas are provided on each of the left and right sides of the center sound-emitting area, 4 sound-emitting areas closest to the center sound-emitting area can be selected from each of the left side and the right side of the center sound-emitting area to form a sound-emitting area group. For example, four sound-emitting areas marked in black on the left side of the center sound-emitting area 401 are a sound-emitting area group, and four sound-emitting areas marked in black on the right side of the center sound-emitting area are another sound-emitting area group. Thus, the 4 sound-emitting areas on each of the left and right sides of the user can emit sound outward, and the sound pressure difference between the left and right ears is small.

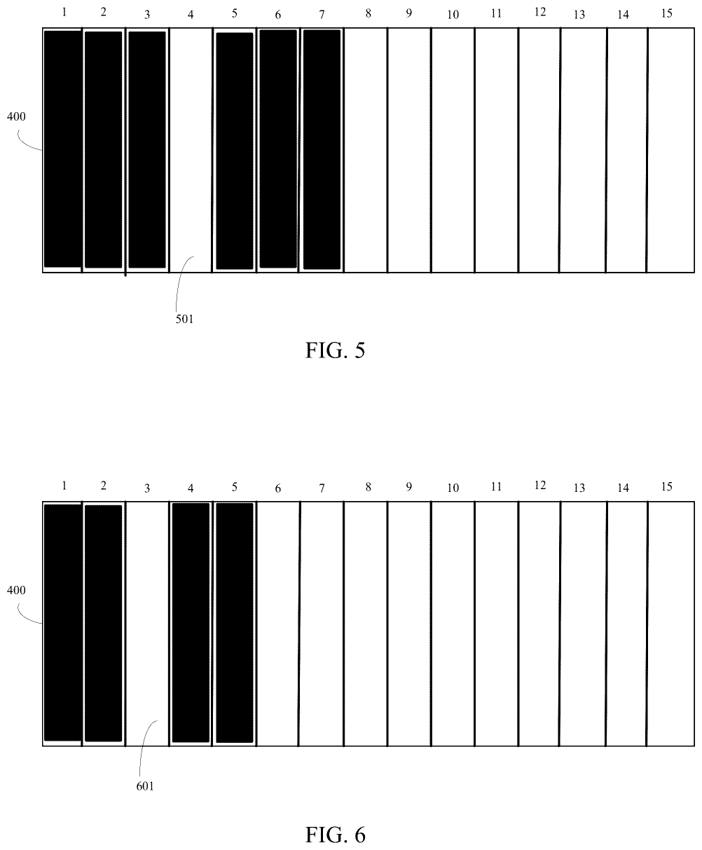

As shown in FIG. 5, the user is not in the center position area of the sound panel. Then, the center sound-emitting area 501 corresponding to the target position of the user relative to the sound panel is the fourth sound-emitting area from left to right. Then, more sound-emitting areas are provided on the right side of the center sound-emitting area 501, and only 3 sound-emitting areas are provided on the left side of the center sound-emitting area. Based on this, to reduce the sound pressure difference of the left and right ears of the user, the 3 sound-emitting areas on the left side of the center sound-emitting area 501 can be determined as the sound-emitting area group, and the 3 sound-emitting areas closest to the center sound-emitting area 501 on the right side of the center sound-emitting area 501 are determined as the other sound-emitting area group. Thus, 3 sound-emitting areas on each of the left side and right side of the user can emit the audio signal.

As shown in FIG. 6, the position of the user is closer to the edge of the sound panel. Only 2 sound-emitting areas are provided on the left side of the center sound-emitting area 601. Thus, two closest sound-emitting areas on each of the left side and the right side of the center sound-emitting area 601 can form a sound-emitting area group.

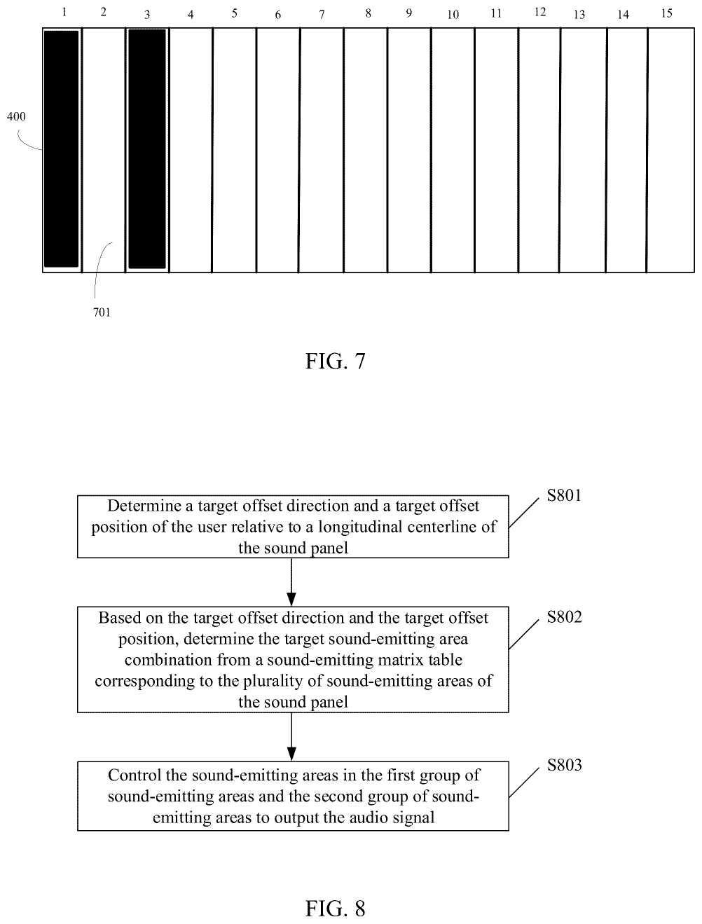

Similarly, in FIG. 7, only 1 sound-emitting area is provided on the left side of the center sound-emitting area 701 corresponding to the target position of the user. Then, a closest sound-emitting area on each of the left side and the right side of the center sound-emitting area 701 can be selected as the sound-emitting area that needs to output the audio signal.

If the position of the user relative to the sound panel is not considered, the total number of sound-emitting areas used to output audio in the sound panel can be set as a fixed value. Then, when the user is at the edge of the sound panel, a large difference may exist between the number of sound-emitting areas on the left side of the user for outputting the audio and the number of sound-emitting areas on the right side of the user for outputting the audio. Then, a large sound pressure difference may result between the left and right ears of the user to impair the user's ability toto hear the audio properly.

However, in the present disclosure, as shown in FIGS. 4 to 7, regardless of how the position of the user is relative to the sound panel, the number of sound-emitting areas for outputting audio on the left side and the number of sound-emitting areas for outputting audio on the right side of the user are the same. Thus, the problem of the large sound pressure difference between the left and right ears of the user caused by the inconsistent numbers of sound-emitting areas for outputting audio on the left and right sides of the user can be greatly reduced to improve the audio output effect.

At S305, sound-emitting areas of the first group of sound-emitting areas and the second group of sound-emitting areas are controlled to output an audio signal.

In the present disclosure, during the process of controlling the first group of sound-emitting areas and the second group of sound-emitting areas to output the audio signal, the center sound-emitting area may or may not output the audio signal. Considering that when the center sound-emitting area emits sound, sound waves can strike the user face but also bring power consumption, which has almost no effect on improving the loudness and sound quality of the audio signal received by the user. Therefore, in some embodiments of the present disclosure, the center sound-emitting area may be controlled not to output the audio signal.

In some embodiments, as shown in FIG. 3, the sound panel generally only provides audio directionally to the user in front of the sound panel. Based on this, if no other sound-emitting area exists on one side of the center sound-emitting area, the user may be considered unsuitable to use the sound panel to provide the audio signal. Then, the sound-emitting areas of the sound panel can be controlled to stop outputting the audio signal.

As shown in FIG. 3, an implementation method for determining the first group of sound-emitting areas and the second group of sound-emitting areas is described as an example. In practical applications, sound-emitting area combinations corresponding to different target positions can be preconfigured in the present disclosure. Each sound-emitting area combination can include a first group of sound-emitting areas and a second group of sound-emitting areas located on two sides of the target position, which is described in connection with FIG. 8.

FIG. 8 is a schematic flowchart of another directional sound control method according to some embodiments of the present disclosure. The method includes the following steps.

At S801, a target offset direction and a target offset position of the user relative to a longitudinal centerline of the sound panel are determined.

The longitudinal centerline of the sound panel can be parallel to the arrangement direction of a single sound-emitting area on the sound panel. When the sound panel is used as a panel capable of directional sound emission, the longitudinal centerline can be the centerline of the sound panel along the vertical direction.

In some embodiments, when the number of sound-emitting areas in the sound panel is odd, the sound-emitting area located at the center of the sound panel can be used as the longitudinal centerline.

The target offset direction can be the relative offset direction relative to the longitudinal centerline of the sound panel. For example, the target offset direction can include offset to the left or right relative to the longitudinal center.

The target offset position can be characterized by the distance displaced relative to the longitudinal centerline or the number of sound-emitting areas displaced relative to the longitudinal centerline, which is not limited. For example, the target offset position can include 4 mm displaced from the bus centerline. In some other embodiments, when the longitudinal centerline is the sound-emitting area located at the center of the sound panel, the target offset position can be the number of sound-emitting areas displaced relative to the center sound-emitting area.

In some embodiments, if the sound panel is arranged on a display unit, the target offset direction and target offset position of the user relative to the longitudinal centerline of the display unit can be determined.

The specific implementation of determining the target offset direction and the target offset position can be achieved by using an image acquisition apparatus, such as a camera, or by using a radar detection apparatus, which is similar to determining the target position above and is not repeated here.

At 802, based on the target offset direction and the target offset position, the target sound-emitting area combination is determined from a sound-emitting matrix table corresponding to the plurality of sound-emitting areas of the sound panel.

The sound-emitting matrix table can include sound-emitting area combinations corresponding to different offset directions and offset positions. Each sound-emitting area combination can include two sound-emitting area groups. For the sound-emitting area combination corresponding to each offset direction and offset position, the two sound-emitting area groups in the sound-emitting area combination can be located on two sides of the position in the sound panel corresponding to the offset direction and the offset position. Moreover, each of the two sound-emitting area groups in the sound-emitting area combination can include the same number of sound-emitting areas.

To facilitate distinguishment, the sound-emitting area combination corresponding to the target offset direction and the target offset position can be referred to as the target sound-emitting area combination. Correspondingly, the target sound-emitting area combination can include the first group of sound-emitting areas and the second group of sound-emitting areas. As mentioned above, the first group of sound-emitting areas and the second group of sound-emitting areas can include the same number of sound-emitting areas. The first group of sound-emitting areas and the second group of sound-emitting areas can be located on the two sides of the target position in the sound panel corresponding to the target offset direction and the target offset position. Moreover, the sound-emitting areas in the first group of sound-emitting areas and the second group of sound-emitting areas can be the sound-emitting areas closest to the target position on the two sides of the target position.

To facilitate understanding, the description can be made in connection with an example.

Assume that the horizontal width of the sound panel can be 596 mm, the sound panel can include 15 sound-emitting areas, and the maximum number of sound-emitting areas in a sound-emitting area group is 4. Based on this, the longitudinal center of the sound panel can be located at the 8th sound-emitting area from left to right, and each time the user position moves 4 cm to the left or right, the user can enter another sound-emitting area. Based on this, in the present disclosure, in front of which sound-emitting area the user currently is can be determined based on the target offset direction and the target offset position of the user relative to the center of the sound panel. The sound-emitting area can be the center sound-emitting area above. Based on this, when the user is in front of different sound-emitting areas, the sound-emitting areas on the left side and right side of the user that need to be started can be determined. Thus, the sound-emitting matrix table can be pre-constructed.

TABLE 1
is an example of a sound-emitting matrix table
pre-constructed in the present disclosure.

| Offset | Offset | | Whether the sound-emitting area is on, 1 means one, and 0 means off | | | | | | | | | | | | | | |
|---|---|---|---|---|---|---|---|---|---|---|---|---|---|---|---|---|---|
| direction | distance | | 1 | 2 | 3 | 4 | 5 | 6 | 7 | 8 | 9 | 10 | 11 | 12 | 13 | 14 | 15 |
| Center | 0 | cm | 0 | 0 | 0 | 1 | 1 | 1 | 1 | 0 | 1 | 1 | 1 | 1 | 0 | 0 | 0 |
| Left | 4 | cm | 0 | 0 | 1 | 1 | 1 | 1 | 0 | 1 | 1 | 1 | 1 | 0 | 0 | 0 | 0 |
| offset | 8 | cm | 0 | 1 | 1 | 1 | 1 | 0 | 1 | 1 | 1 | 1 | 0 | 0 | 0 | 0 | 0 |
| | 12 | cm | 1 | 1 | 1 | 1 | 0 | 1 | 1 | 1 | 1 | 0 | 0 | 0 | 0 | 0 | 0 |
| | 16 | cm | 1 | 1 | 1 | 0 | 1 | 1 | 1 | 0 | 0 | 0 | 0 | 0 | 0 | 0 | 0 |
| | 20 | cm | 1 | 1 | 0 | 1 | 1 | 0 | 0 | 0 | 0 | 0 | 0 | 0 | 0 | 0 | 0 |
| | 24 | cm | 1 | 0 | 1 | 0 | 0 | 0 | 0 | 0 | 0 | 0 | 0 | 0 | 0 | 0 | 0 |
| | 28 | cm | 0 | 0 | 0 | 0 | 0 | 0 | 0 | 0 | 0 | 0 | 0 | 0 | 0 | 0 | 0 |
| Right | 4 | cm | 0 | 0 | 0 | 0 | 1 | 1 | 1 | 1 | 0 | 1 | 1 | 1 | 1 | 0 | 0 |
| offset | 8 | cm | 0 | 0 | 0 | 0 | 0 | 1 | 1 | 1 | 1 | 0 | 1 | 1 | 1 | 1 | 0 |
| | 12 | cm | 0 | 0 | 0 | 0 | 0 | 0 | 1 | 1 | 1 | 1 | 0 | 1 | 1 | 1 | 1 |
| | 16 | cm | 0 | 0 | 0 | 0 | 0 | 0 | 0 | 0 | 1 | 1 | 1 | 0 | 1 | 1 | 1 |
| | 20 | cm | 0 | 0 | 0 | 0 | 0 | 0 | 0 | 0 | 0 | 0 | 1 | 1 | 0 | 1 | 1 |
| | 24 | cm | 0 | 0 | 0 | 0 | 0 | 0 | 0 | 0 | 0 | 0 | 0 | 0 | 1 | 0 | 1 |
| | 28 | cm | 0 | 0 | 0 | 0 | 0 | 0 | 0 | 0 | 0 | 0 | 0 | 0 | 0 | 0 | 0 |

In the above sound-emitting matrix table, if a sound-emitting area belongs to a sound-emitting area group, an activation instruction sign corresponding to the sound-emitting area is 1, and otherwise, an activation instruction corresponding to the sound-emitting area is 0. Meanwhile, after the user is displaced relative to the longitudinal center line, the activation instruction sign corresponding to the sound-emitting area (i.e., the center sound-emitting area above) faced by the user is 0, which is black and bold for distinguishment.

As shown in the above sound-emitting matrix table 1, if the user is not displaced relative to the longitudinal center line of the sound panel, the user is at the 8^{th} sound-emitting area. Four sound-emitting areas on the left side of the 8^{th} sound-emitting area can be used as a sound-emitting area group. That is, the 4^{th} to 7^{th} sound-emitting areas can be used as the sound-emitting area group. Four sound-emitting areas on the right side of the 8^{th} sound-emitting area can be used as a sound-emitting area group. That is, the 9^{th} to 12^{th} sound-emitting areas can be used as the sound-emitting area group. Then, the sound-emitting area group formed by the 4^{th} to 7^{th} sound-emitting areas and the sound-emitting area group formed by the 9^{th} to 12^{th} sound-emitting areas can form a sound-emitting area combination, which is the same as the FIG. 4.

If the user is displaced by 16 cm to the left relative to the longitudinal center line of the sound panel, the user is actually located at the front of the 4^{th} sound-emitting area. Then, the number of the sound-emitting areas on the left side of the user is less than 4. Only three sound-emitting areas are provided. Then, the 1^{st} to 3^{rd} sound-emitting areas can be determined as a sound-emitting area group, and the 5^{th} to 7^{th} sound-emitting areas can be determined as another sound-emitting area group. So on so forth, which is not described one by one.

At S803, the sound-emitting areas in the first group of sound-emitting areas and the second group of sound-emitting areas are controlled to output the audio signal.

In embodiments of the present disclosure, the number of sound-emitting areas on the sound panel and the width of the sound-emitting area can be set as needed. Moreover, the sound-emitting areas on the sound panel can be pre-designed before leaving the factory and will not be changed later. Of course, considering the differences in head width among different users, in the present disclosure, the sound-emitting area can be determined according to the head reference feature of the user who currently uses the sound panel. Thus, the number of the sound-emitting areas of the sound panel and the width may be different at different times.

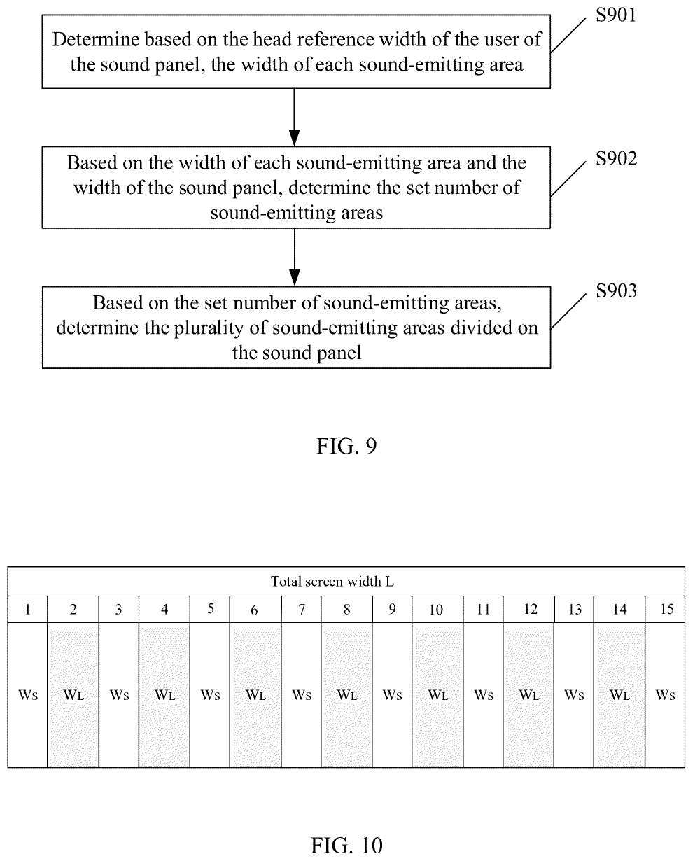

An implementation of determining the plurality of sound-emitting areas of the sound panel can be described as an example. FIG. 9 is a schematic flowchart of determining a plurality of sounding areas of a sound panel according to some embodiments of the present disclosure. The process includes the following steps.

At S901, based on the head reference width of the user of the sound panel, the width of each sound-emitting area is determined.

The head reference width of the user can be the width of the user face, the width of a certain part of the head, or the distance between the two ears of the user, which is not limited.

In some embodiments of the present disclosure, the sound-emitting areas of the sound panel that are suitably divided can be determined for the user who currently uses the sound panel after the sound panel leaves the factory. Thus, the user can be the user who currently uses the sound panel. Correspondingly, the width of the sound-emitting area can be determined based on the face width of the user or the distance between the two ears. For example, after the sound panel leaves the factory, the user may first use the sound panel, and need to trigger the sound panel to divide the sound-emitting areas. Thus, the sound-emitting areas can be divided in embodiments of the present disclosure. For another example, after each time the electronic device is powered on, the electronic device can perform the operation of the process for the current user to more suitably determine the plurality of sound-emitting areas that can be suitably divided on the sound panel.

Of course, in embodiments of the present disclosure, the plurality of sound-emitting areas that need to be divided on the sound panel can be determined before the sound panel leaves the factory. Then, the user can be a standard user, who can represent the head reference width for most users. For example, the width between two ears of most people can be obtained and used as the head reference width of the user.

The width of each sound-emitting area can be half or one-quarter of the head reference width, and have other possibilities, which are not limited.

At S902, based on the width of each sound-emitting area and the width of the sound panel, the set number of sound-emitting areas is determined.

The set number of sound-emitting areas can be the number of sound-emitting areas that need to be set.

For example, the set number of sound-emitting areas can be obtained by dividing the width of the sound panel by the width of the sound-emitting area to obtain the set number of sound-emitting areas. In practical applications, the quotient of the width of the sound panel divided by the width of the sound-emitting area may not necessarily be an integer. If the quotient is not an integer, an integer closest to the quotient can be selected as the set number of sound-emitting areas. For example, the smallest integer greater than the quotient or the odd number closest to the quotient can be selected as the set number of sound-emitting areas.

At S903, based on the set number of sound-emitting areas, the plurality of sound-emitting areas divided on the sound panel are determined.

When the set number of sound-emitting areas is determined, the sound panel can be divided into the set number of sound-emitting areas.

For example, after determining the set number of sound-emitting areas, the width of each sound-emitting area can also be re-determined. For example, when the set number is not the quotient obtained by dividing the width of the sound panel by the width of the sound-emitting area, the width of the sound-emitting area can be recalculated based on the width of the sound panel and the set number of sound-emitting areas. The recalculated width of the sound-emitting area can be used as the final width of each sound-emitting area. Accordingly, based on the recalculated width of the sound-emitting area and the set number of sound-emitting areas, the plurality of sound-emitting areas can be sequentially divided along the horizontal direction of the sound panel.

To facilitate understanding, for example, the distance between the two ears of the user can be used as the head reference width of the user. Generally, the distance between the two ears of the user is between 160 mm and 190 mm. Based on this, when the distance between the two ears of the user differs, half of or a quarter of the distance between the two ears of the user can be used as the width of the sound-emitting area. Thus, a plurality of possibilities can be provided. As shown in Table 2, when the distance between the two ears of the user is different, the width of the sound-emitting area can have different values corresponding to half of or a quarter of the distance between the two ears.

TABLE 2

| Distance | The width of the sound- | The width of the sound- | |
|---|---|---|---|
| between | emitting area being half of | emitting area being quarter of | |
| two ears | the distance between two ears | the distance between two ears | |
| 160 mm | 80 mm | 40 | mm |
| 170 mm | 85 mm | 42.5 | mm |
| 180 mm | 90 mm | 45 | mm |
| 190 mm | 95 mm | 47.5 | mm |

As shown in Table 2 above, when the distance between the two ears of the user is 160 mm, if half of the distance between the two ears is used as the width of the sound-emitting area, the width of the sound-emitting area is 80 mm. Other situations are similar and are not described one by one.

Based on Table 2, the width of the sound-emitting area can be a quarter of the distance between the two ears. In Table 3, when the lateral width of the sound panel is different, different numbers of sound-emitting areas can be divided on the sound panel.

TABLE 3

| | |
|---|---|
| Width of sound- | Panel Width |

| | | | |
|---|---|---|---|
| emitting area | 480 mm | 600 mm | 700 mm |

| | | | | |
|---|---|---|---|---|
| 40 | mm | 12 | 15 | 17.5 |
| 42.5 | mm | 11.3 | 14.1 | 16.5 |
| 45 | mm | 10.7 | 13.3 | 15.6 |
| 47.5 | mm | 10.1 | 12.6 | 14.7 |

In Table 3, under different widths of the sound-emitting area and different panel widths of the sound panel, the number of sound-emitting areas divided on the sound panel can be determined. For example, when the width of the sound-emitting area is 40 mm, and the panel width of the sound panel is 480 mm, the number of sound-emitting areas that can be divided can be 12. If the width of the sound-emitting area that is initially calculated is 40 mm, when the width of the sound panel is 600 mm, 15 sound-emitting areas can be divided on the sound panel, and the width of each sound-emitting area can be 40 mm.

However, if the initially calculated width of the sound-emitting area is 42.5 mm, and the width of the sound panel is 600 mm, the calculated number of sound-emitting areas can be 14.1, which is not an integer. Then, 14 sound-emitting areas that need to be divided on the sound panel can be determined, and the width of each sound-emitting area can be recalculated to determine the sound-emitting areas of the sound panel. In some other embodiments, an integer of 15 greater than 14.1 can be selected based on 14.1. Then, 15 sound-emitting areas can be provided according to the needs of the sound panel. The width of each sound-emitting area can be recalculated to determine the areas corresponding to the sound-emitting areas of the sound panel.

In embodiments of the present disclosure, for example, each sound-emitting area on the sound panel has the same width. In practical applications, the widths of the sound-emitting areas on the sound panel may not be the same.

In some embodiments, the plurality of sound-emitting areas on the sound panel can include a plurality of first sound-emitting areas and a plurality of second sound-emitting areas. The width of a first sound-emitting area and the width of a second sound-emitting area can be different. Based on this, each of the first group of sound-emitting areas and the second group of sound-emitting areas determined in the present disclosure can include the same number of first sound-emitting areas and the same number of second sound-emitting areas.

For example, the first sound-emitting areas and the second sound-emitting areas in the sound panel can be alternatively arranged. A second sound-emitting area can be arranged between any two first sound-emitting areas.

To facilitate understanding, for example, the sound panel can be arranged at the display unit (screen) of an electronic device. Then, the width of the screen of the electronic device can be the width of the sound panel. As shown in FIG. 10, assume that the total width L of the screen of the electronic device is L. As shown in FIG. 10, the screen of the electronic device includes 15 sound-emitting areas (i.e., sound channels). The 15 sound-emitting areas can include two types of sound-emitting areas with different widths, i.e., sound-emitting area W_{S} and sound-emitting area W_{L}. The width of the sound-emitting area W_{S} can be relatively narrow, and the width of the sound-emitting area W_{L} can be relatively wide. A sound-emitting area W_{L} can be arranged between two sound-emitting areas W_{S} to allow the two different types of sound-emitting areas to be arranged alternatively.

When the sound panel includes the first sound-emitting areas and the second sound-emitting areas with two different widths, the implementation of determining the first group of sound-emitting areas and the second group of sound-emitting areas based on the target position of the user relative to the sound panel can be similar to the above. Since the first sound-emitting areas and the second sound-emitting areas are alternatively arranged, the first group of sound-emitting areas and the second group of sound-emitting areas determined according to the above implementation can have the same number of sound-emitting areas. Moreover, the first group of sound-emitting areas and the second group of sound-emitting areas can include the same number of first sound-emitting areas, and the same number of second-emitting areas. Thus, the width of the first group of sound-emitting areas can be the same as the width of the second group of sound-emitting areas.

By providing the sound-emitting areas with two different widths in the sound panel, when the user is at the edge of the sound panel, the width of the first group of sound-emitting areas and the second group of sound-emitting areas can be possibly large to allow the area of the sound panel that can output audio can be possibly large to be beneficial in improving the user experience.

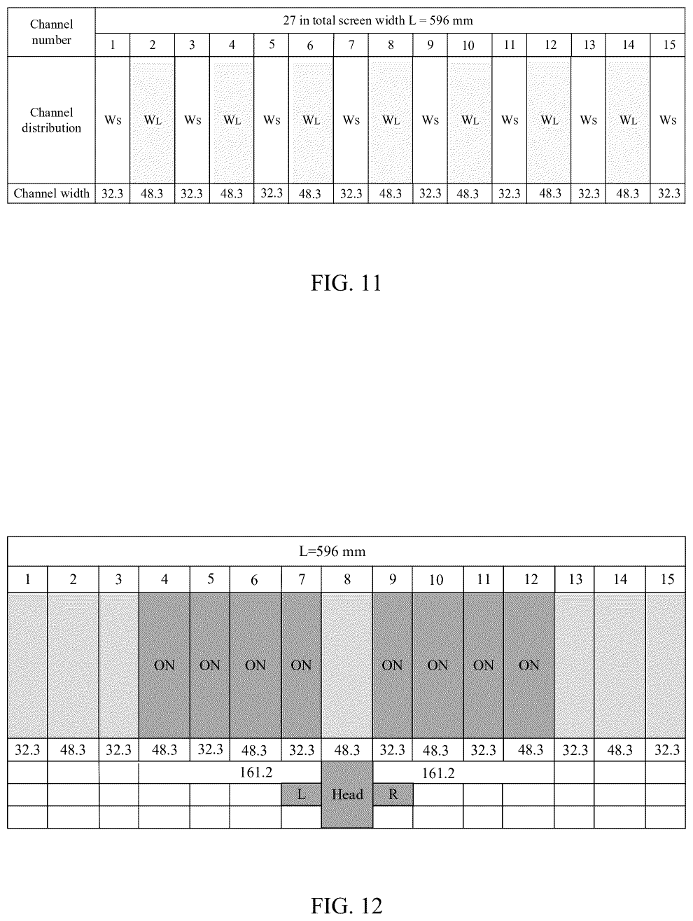

To facilitate understanding, a description can be made in connection with FIGS. 11 to 18. For example, the sound panel is still on the screen of the electronic device in FIGS. 11 to 18.

For example, in FIG. 11, the size L of the screen is 27 inches, converted into millimeters, L=596 mm. Assume that the widths of the two types of sound-emitting areas are sound-emitting area W_{S}=32.3 mm, and sound-emitting area W_{L}=48.3 mm. In FIG. 11, the sound-emitting area is referred to as a sound channel. In FIG. 11, the sound channels are marked with the width type to which the sound channels belong and the width of the sound channels.

FIGS. 12 to 18 are based on FIG. 11 and show the sound-emitting areas on the screen that need to be turned on and output audio when the user head is at different positions relative to the screen. In FIG. 12 to FIG. 18, the left side of the user head is marked as L, and the right side of the user head is marked as R. The sound-emitting areas that need to be turned on are marked in dark gray. As shown in FIG. 12, the sound-emitting area that need to be turned on are also labeled with “ON.”

In FIGS. 12 to 18, the target number is still taken as 4 for description.

As shown in FIG. 12, when the user head is at the 8^{th} sound-emitting area, since more than 4 sound-emitting areas are provided on each of the left side and the right side of the 8^{th} sound-emitting area, the 4^{th}, 5^{th}, 6^{th}, and 7^{th} sound-emitting areas on the left side of the 8^{th} sound-emitting area are determined as the first group of sound-emitting areas, and the 9^{th}, 10^{th}, 11^{th}, and 12^{th} sound-emitting areas on the right side of the 8^{th} sound-emitting area are determined as the second group of sound-emitting areas. The number of sound-emitting areas in the first group of sound-emitting areas and the number of sound-emitting areas of the second group of sound-emitting areas can be the same. Furthermore, as shown in FIG. 11 and FIG. 12, the first group of sound-emitting areas includes two sound-emitting areas W_{L} with relatively large widths and two sound-emitting areas W_{S} with relatively small widths. Correspondingly, the second group of sound-emitting areas also includes two sound-emitting areas W_{L} and two sound-emitting areas W_{S}.

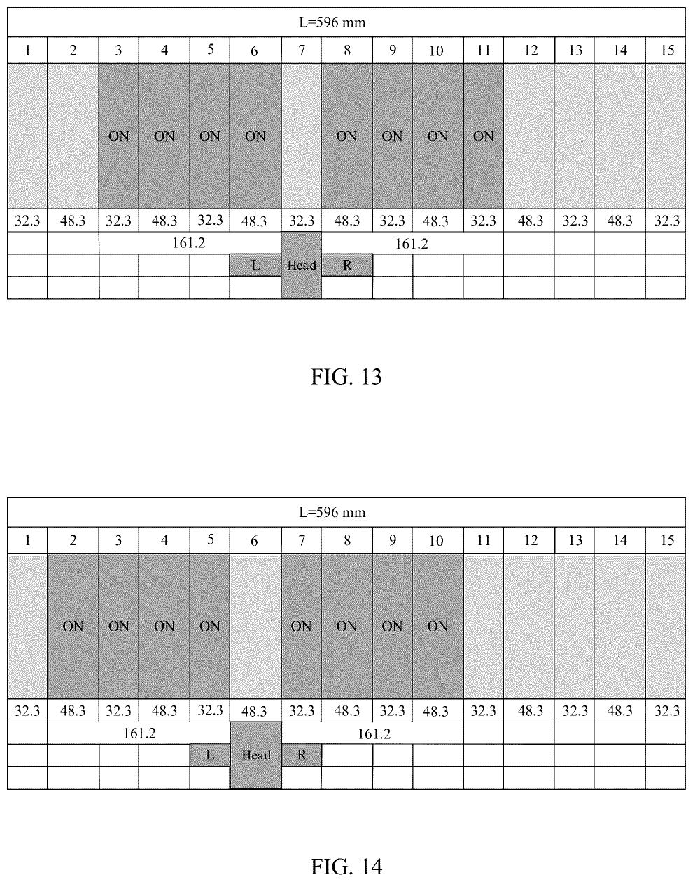

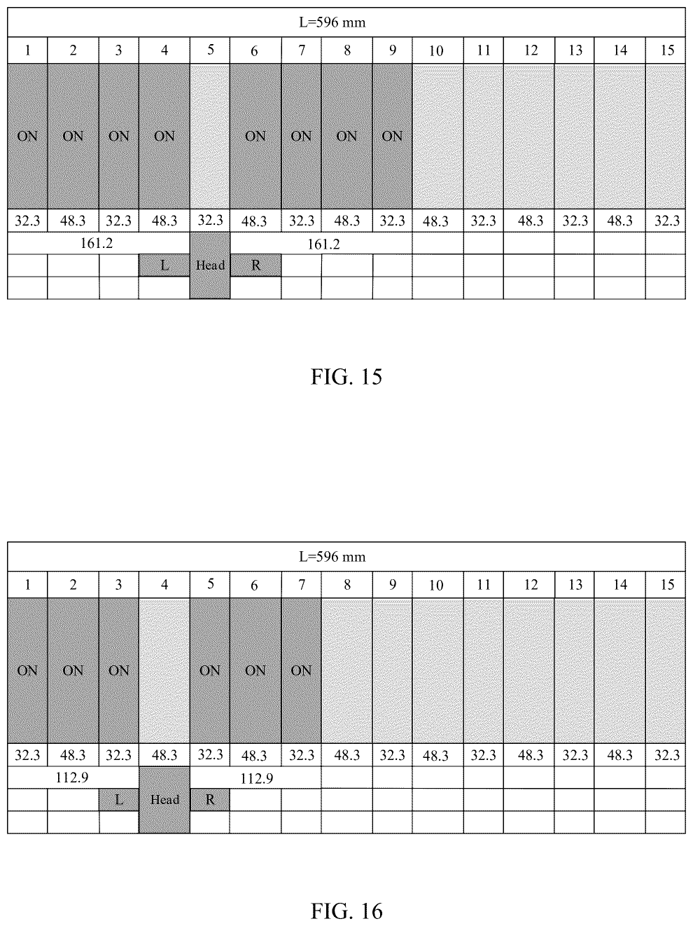

Similarly, as shown in FIG. 13, FIG. 14, and FIG. 15, when the user head moves to be in front of the 7^{th} sound-emitting area, the 6^{th} sound-emitting area, or the 5^{th} sound-emitting area, the implementation of determining the first group of sound-emitting areas and the second group of sound-emitting areas is similar to the implementation in FIG. 12, which will not be repeated here.

The user head moves to be in front of the 4th sound-emitting area as shown in FIG. 16. Since only three sound-emitting areas are provided on the left side of the 4^{th} sound-emitting area, the 1^{st} to 3^{rd} sound-emitting areas on the left side of the 4^{th} sound-emitting area can be determined as the first group of sound-emitting areas, and the 5^{th} to 7^{th} sound-emitting areas on the right side of the 4^{th} sound-emitting area can be determined as the second group of sound-emitting areas. In connection with FIG. 11 and FIG. 16, each of the determined first group of sound-emitting areas and the second group of sound-emitting areas includes one sound-emitting area W_{L} and two sound-emitting areas W_{S}. Thus, the total width of the sound channels on the left side and the total width of the sound channels on the right side of the user head can be the same.

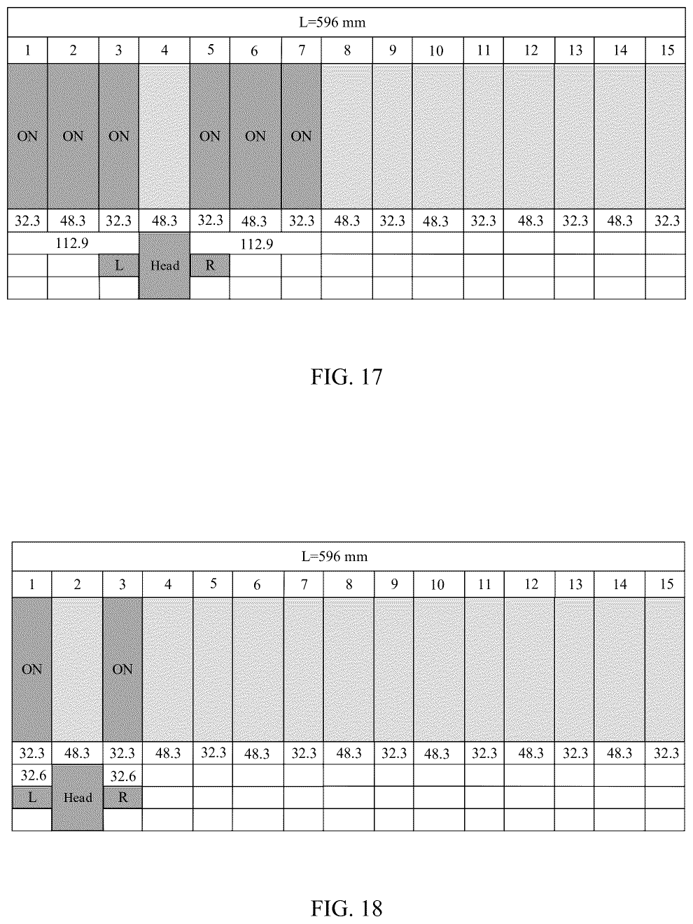

Similar to FIG. 16, in FIG. 17, the user head is at the front end of the 3^{rd} sound-emitting area. Then, the 1^{st} and 2^{nd} sound-emitting areas on the left side of the user head need to be turned on, and the 4^{th} and 5^{th} sound-emitting areas on the right side of the user head also need to be turned on. In connection with FIG. 11 and FIG. 17, the number of the two types of sound-emitting areas that are turned on at the left side of the user head and the number of the two types of sound-emitting areas that are turned on at the right side of the user head are the same. Thus, the total width of the sound channels on the left side of the user head and the total width of the sound channels on the right side of the user head are still the same.

Moreover, as shown in FIG. 17, the total width of the sound channels on the left side and the total width of the sound channels on the right side of the user are both 80.6 mm. If the widths of all sound channels are the same, for the 27-inch screen shown in FIG. 11, the width of each sound channel should be 39.7 mm. Then, after two sound channels on the left side of the user head are turned on, the total width of the two sound channels is only 79.4 mm. Accordingly, the total width of the sound channels turned on at the right side of the user head is also 79.4 mm. The total width of the sound channels used for sound emission is less than the total width of 80.6 mm shown in FIG. 16. Therefore, the solution of using sound channels with different widths can, when the user is located at the edge, increase the width of the sound channels under the premise of reducing the sound pressure difference between the left and right ears of the user, which can improve the audio volume to a certain degree.

The situation in FIG. 18 is similar to the situation in FIG. 17 and is not repeated here.

When two types of sound-emitting areas with different widths are provided in the sound panel, a plurality of possible implementations can be provided to determine the sound-emitting areas divided on the sound panel. One implementation is described below as an example.

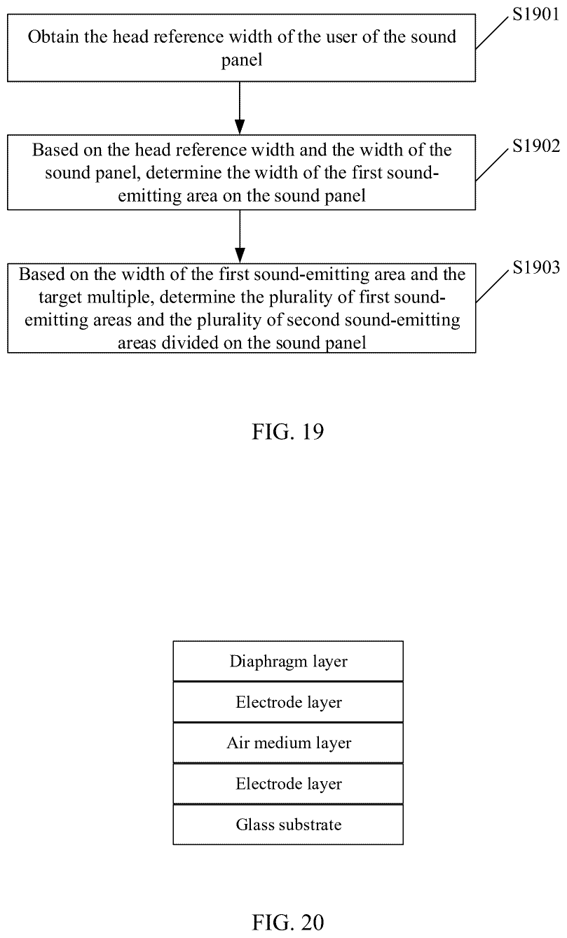

For example, the width of the second sound-emitting area can be a target multiple of the width of the first sound-emitting area. For example, the target multiple can be a value greater than 1. FIG. 19 is another schematic flowchart of determining a plurality of sounding areas in a sound panel according to some embodiments of the present disclosure. The process includes the following steps.

At S1901, the head reference width of the user of the sound panel is obtained.

For this step, reference can be made to the description of the above embodiments, which is not repeated here.

Similar to FIG. 9, embodiments of the present disclosure can also be applied to the electronic device to determine the sound-emitting area of the sound panel in real-time. In some other embodiments, the sound-emitting areas of the sound panel can be determined before the sound panel leaves the factory to finish the setting of the sound-emitting areas.

At S1902, based on the head reference width and the width of the sound panel, the width of the first sound-emitting area on the sound panel is determined.

For example, the width of the first sound-emitting area can be the width of the sound panel divided by the head reference width. In connection with FIG. 11, the first sound-emitting area is the sound-emitting area W_{S}, and the second sound-emitting area is the sound-emitting area W_{L}. In FIG. 11, the screen size is 596 mm. That is, the width of the sound panel is 596 mm. Assume the head reference width is 18.5 mm, the sound-emitting area W_{S}=596/18.5=32.3 mm, and sound-emitting area W_{L}=48.3 mm.

Of course, the width of the sound panel can also be divided by half of the head reference width as the width of the first sound-emitting area. The width of the first sound-emitting area can be determined in other methods, which are not limited.

At S1903, based on the width of the first sound-emitting area and the target multiple, the plurality of first sound-emitting areas and the plurality of second sound-emitting areas divided on the sound panel are determined.

Based on the target multiple and the width of the first sound-emitting area, the width of the second sound-emitting area can be determined. After the width of the first sound-emitting area and the width of the second sound-emitting area are determined, the first sound-emitting areas and the second sound-emitting areas can be alternately determined on the sound panel.

The sound panel can be arranged on the upper layer of the display unit of the electronic device. Then, if the display unit also rotates around a rotating member, the arrangement direction of the sound-emitting areas on the sound panel can be perpendicular to the standing direction of the user. If the arrangement direction of a single sound-emitting area is perpendicular to the standing direction of the user, any one of the sound-emitting areas may not be individually located on one side of the user. Therefore, the directional sound emission may not be performed using the sound panel. Only when each sound-emitting area of the sound panel is arranged in the vertical direction, the directional sound emission of the present disclosure can be performed.

Accordingly, only when the display unit is in the target posture, the target position of the user relative to the display unit can be determined. Other operations mentioned above can be performed based on the target position to realize the directional sound emission control. When the display unit is in the target posture, the shorter side edge of the display unit can be parallel with the image display direction of the display unit displaying the image. The direction in which the display unit displays the image can be the direction in which the display unit represents the image.

To facilitate understanding the situation of arranging the sound panel on the upper layer of the display unit, FIG. 20 is a schematic structural diagram of each sounding area in the sound panel arranged on the upper layer of the display unit according to some embodiments of the present disclosure.

As shown in FIG. 20, an air medium layer and a diaphragm layer are provided on the upper layer of a glass substrate of the display unit, an electrode layer is provided between the air medium layer and the diaphragm layer, and an electrode layer is also provided between the glass substrate and the diaphragm layer. After the electrode layers are powered on, a magnetic field can be generated to drive the diaphragm layer to vibrate in a direction perpendicular to the glass substrate to generate sound waves.

The directional sound control method of embodiments of the present disclosure is described above. An apparatus for performing the directional sound control method is described below.

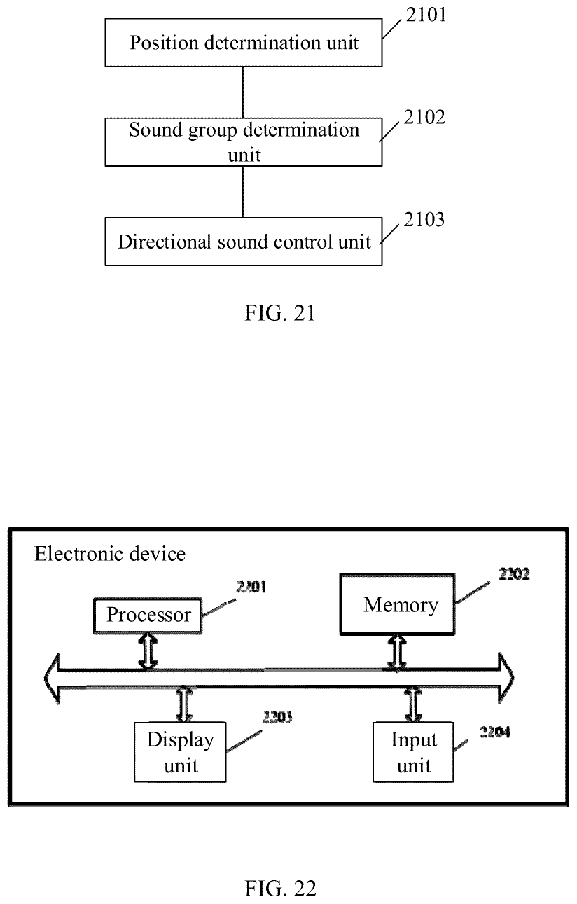

FIG. 21 is a schematic structural diagram of a directional sound control apparatus according to some embodiments of the present disclosure. As shown in FIG. 21, the direction sound control apparatus includes a position determination unit 2101, a sound group determination unit 2102, and a directional sound control unit 2103.

The position determination unit 2101 can be configured to determine the target position of the user relative to the sound panel.

The sound group determination unit 2102 can be configured to, based on the target position, determine the first group of sound-emitting areas and the second group of sound-emitting areas from the plurality of sound-emitting areas of the sound panel. The sound-emitting areas can be arranged longitudinally along the sound panel, and the plurality of sound-emitting areas can be arranged sequentially in parallel. The first group of sound-emitting areas and the second group of sound-emitting areas can be located on the two sides of the target position and adjacent to the target position. The first group of sound-emitting areas and the second group of sound-emitting areas each include at least one sound-emitting area. The number of sound-emitting areas in the first group of sound-emitting areas and the number of sound-emitting areas in the second group of sound-emitting areas can be the same. When the target position is different, the number of sound-emitting areas determined in the first group of sound-emitting areas can be different.

The directional sound control unit 2103 can be configured to control the sound-emitting areas within the first group of sound-emitting areas and the second group of sound-emitting areas to output an audio signal.

In some embodiments, the plurality of sound-emitting areas of the sound panel can include the plurality of first sound-emitting areas and the plurality of second sound-emitting areas. The width of the first sound-emitting areas and the width of the second sound-emitting areas can be different.

The first group of sound-emitting areas and the second group of sound-emitting areas determined by the sound group determination unit each can include the same number of first sound-emitting areas and the same number of second sound-emitting areas.

In some other embodiments, the sound group determination unit can include a center area determination sub-unit and a sound group determination sub-unit.

The center area determination sub-unit can be configured to determine the center sound-emitting area corresponding to the user from the plurality of sound-emitting areas of the sound panel based on the target position.

The sound group determination sub-unit can be configured to, according to the target number and the number of sound-emitting areas on the left side and the number of sound-emitting areas on the right side of the center sound-emitting area, determine the first group of sound-emitting areas and the second group of sound-emitting areas that are located on the two sides of and adjacent to the center sound-emitting area. The number of sound-emitting areas in the first group of sound-emitting areas and the number of sound-emitting areas in the second group of sound-emitting areas may not exceed the target number. The target number can be the maximum number of sound-emitting areas set for a sound-emitting area group.

In some other embodiments, the sound group determination sub-unit can include a first group determination sub-unit and a second group determination sub-unit.

The first group determination sub-unit can be configured to, if not less than the target number of other sound-emitting areas are provided on each of the two sides of the center sound-emitting area, determine the first group of sound-emitting areas and the second group of sound-emitting areas on the two sides of and adjacent to the center sound-emitting area. The first group of sound-emitting areas and the second group of sound-emitting areas each can include the target number of sound-emitting areas.

The second group determination sub-unit can be configured to, if a total number of other sound-emitting areas on one side of the center sound-emitting area is not less than 1 but less than the target number, based on the total number, determine the first group of sound-emitting areas and the second group of sound-emitting areas that are located on the two sides of and adjacent to the center sound-emitting area. The first group of sound-emitting areas and the second group of sound-emitting areas each can include the total number of sound-emitting areas.

In some other embodiments, the position determination unit can include a position determination sub-unit configured to determine the target offset direction and the target offset position of the user relative to the longitudinal centerline of the sound panel.

The sound group determination unit can include a sound group positioning sub-unit configured to, based on the target offset direction and the target offset position, determine a target sound-emitting area combination from the sound-emitting matrix table corresponding to the plurality of sound-emitting areas of the sound panel. The sound-emitting matrix table can include sound-emitting area combinations corresponding to different offset directions and offset positions. The target sound-emitting area combination can include the first group of sound-emitting areas and the second group of sound-emitting areas.

In some other embodiments, the sound panel can be located on the upper layer of the display unit of the electronic device. The display unit can rotate around the rotation member.

The position determination unit can be specifically configured to, when the display unit is in the target posture, determine the target position of the user relative to the display unit. When the display unit is in the target posture, the shorter side of the display unit can be parallel to the image display direction of the display unit displaying the image.

In some other embodiments, the apparatus can further include a sound-emitting width determination unit, a quantity determination unit, and a first partition unit.

The sound-emitting width determination unit can be configured to determine the width of each sound-emitting area based on the head reference width of the user of the sound panel.

The quantity determination unit can be configured to determine the set number of sound-emitting areas based on the width of each sound-emitting area and the width of the sound panel.

The first partition unit can be configured to, based on the set number of sound-emitting areas, determine the plurality of sound-emitting areas divided on the sound panel.

In some other embodiments, the width of the second sound-emitting area can be a target multiple of the width of the first sound-emitting area. The target multiple can be a value greater than 1.

Based on this, the apparatus can include a width acquisition unit, an area width determination unit, and a second partition unit.

The width acquisition unit can be configured to obtain the head reference width of the user of the sound panel.

The area width determination unit can be configured to, determine the width of the first sound-emitting area in the sound panel based on the head reference width and the width of the sound panel.

The second partition unit can be configured to, based on the width of the first sound-emitting area and the target multiple, determine the plurality of first sound-emitting areas and the plurality of second sound-emitting areas divided on the sound panel.

Embodiments of the present disclosure further provide an electronic device. FIG. 22 is a schematic structural diagram of an electronic device according to some embodiments of the present disclosure. The electronic device at least includes a processor 2201 and a memory 2202.

The processor 2201 can be configured to execute the directional sound control method described above.

The memory 2202 can be configured to store the programs required for the processor to perform operations.

Of course, the electronic device can include a sound panel (not shown).

In some embodiments, the electronic device may further include a display unit 2203. The sound panel can be arranged at the display unit 2203.

The electronic device further includes an input unit 2204.

Of course, the electronic device can also include more or fewer members than the members shown in FIG. 22, which is not limited here.

Embodiments of the present disclosure further provide a computer program product including computer-readable instructions that, when executed on the electronic device, cause the electronic device to implement any one of the directional sound control methods provided in embodiments of the present disclosure.

Embodiments of the present disclosure further provide a computer-readable storage medium, which carries one or more computer programs that, when executed by the electronic device, cause the electronic device to implement any one of the directional sound control methods provided in embodiments of the present disclosure.

The apparatus embodiments described above are merely exemplary. The units described as separate members may or may not be physically separated. The members displayed as units may or may not be physical units. That is, the members can be located in one place or distributed across a plurality of network units. Some or all of the modules can be selected based on actual needs to achieve the objectives of embodiments of the present disclosure. In addition, in the accompanying drawings of the apparatus embodiments of the present disclosure, the connection relationships between the modules can indicate communication connections therebetween, which can specifically be implemented as one or more communication buses or signal lines.

Through the description of the above embodiments, those skilled in the art can clearly understand that the present disclosure can be implemented using software plus necessary general hardware, or can also be implemented using dedicated hardware, including dedicated integrated circuits, dedicated CPUs, dedicated memory, dedicated devices, and so on. Generally, any functionality completed by a computer program can easily be implemented by corresponding hardware, and the specific hardware structure for implementing the same functionality can also be diverse, such as analog circuits, digital circuits, or dedicated circuits. However, for the present disclosure, implementation using software programs is a preferable implementation in most cases. Based on this understanding, the technical solutions of the present disclosure can essentially, or the part of the technical solutions contributing to the existing technology can be embodied in the form of a software product. The computer software product can be stored in a readable storage medium, such as a computer floppy disk, USB flash drive, portable hard disk, ROM, RAM, magnetic disk, or optical disk, and include several instructions to enable a computer device (e.g., a personal computer, training device, or network device, etc.) to execute the methods described in embodiments of the present disclosure.

The above embodiments can be realized entirely or partially through software, hardware, firmware, or any combination thereof. When implemented using software, the embodiments can be entirely or partially implemented in the form of a computer program product.

The computer program product can include one or more computer instructions. When the computer instructions are loaded and executed on the computer, all of or a part of the processes or functions described in embodiments of the present disclosure can be generated. The computer can be a general-purpose computer, a dedicated computer, a computer network, or other programmable apparatuses. The computer instructions can be stored in a computer-readable storage medium or transmitted from one computer-readable storage medium to another computer-readable storage medium. For example, the computer instructions can be transmitted from one website, computer, training device, or data center to another website, computer, training device, or data center via wired (e.g., a coaxial cable, optical fiber, Digital Subscriber Line (DSL)) or wireless (e.g., infrared, wireless, microwave, etc.) means. The computer-readable storage medium can be any available medium that a computer can store or a data storage device, such as a training device or data center that contains one or more integrated available media. The available media can be magnetic media (e.g., floppy disks, hard disks, magnetic tapes), optical media (e.g., DVDs), or semiconductor media (e.g., Solid State Disks (SSD)), etc.

What is claimed is:

1. A directional sound control method, applied to an electronic device, comprising:
determining a target position of a user relative to a sound panel;
based on the target position, determining a first group of sound-emitting areas and a second group of sound-emitting areas from a plurality of sound-emitting areas of the sound panel, wherein the sound-emitting areas are arranged longitudinally along the sound panel, the plurality of sound-emitting areas are arranged sequentially in parallel, the first group of sound-emitting areas and the second group of sound-emitting areas are located on two sides of and adjacent to the target position, each of the first group of sound-emitting areas and the second group of sound-emitting areas includes at least one sound-emitting area, the first group of sound-emitting areas and the second group of sound-emitting areas include a same number of sound-emitting areas, and the number of sound-emitting areas identified in the first group of sound-emitting areas changes when the target position changes; and
controlling sound-emitting areas in the first group of sound-emitting areas and sound-emitting areas in the second group of sound-emitting areas to output an audio signal.

2. The directional sound control method according to claim 1, wherein determining the first group of sound-emitting areas and the second group of sound-emitting areas from the plurality of sound-emitting areas of the sound panel based on the target position includes:
determining a center sound-emitting area corresponding to a user from the plurality of sound-emitting areas of the sound panel based on the target position; and
according to a target number and a respective number of sound-emitting areas on the two sides of the center sound-emitting area, determining the first group of sound-emitting areas and the second group of sound-emitting areas located on the two sides of and adjacent to the center sound-emitting area, wherein the number of sound-emitting areas in the first group of sound-emitting areas and the number of sound-emitting areas in the second group of sound-emitting areas do not exceed the target number, and the target number is a preset maximum number of sound-emitting areas in a sound-emitting area group.

3. The directional sound control method according to claim 2, wherein determining the first group of sound-emitting areas and the second group of sound-emitting areas located on the two sides of and adjacent to the center sound-emitting area according to the target number and the respective number of sound-emitting areas on the two sides of the center sound-emitting area includes:
in response to more than or equal to the target number of other sound-emitting areas being provided on each of the two sides of the center sound-emitting area, determining the first group of sound-emitting areas and the second group of sound-emitting areas located on the two sides of and adjacent to the center sound-emitting area, wherein the first group of sound-emitting areas and the second group of sound-emitting areas each include the target number of sound-emitting areas; and
in response to a total number of other sound-emitting areas on one side of the center sound-emitting area being more than or equal to 1 but less than the target number, determining the first group of sound-emitting areas and the second group of sound-emitting areas located on the two sides of and adjacent to the center sound-emitting area based on the total number, wherein the first group of sound-emitting areas and the second group of sound-emitting areas each include the total number of sound-emitting areas.

4. The directional sound control method according to claim 1, wherein:
the sound panel is arranged on an upper layer of a display unit of the electronic device, and the display unit is rotatable around a rotation member; and
determining the target position of the user relative to the sound panel includes:
determining the target position of the user relative to the display unit in response to the display unit being in a target posture, wherein when the display unit is in the target posture, a shorter side of the display unit is parallel to an image display direction of the display unit displaying an image.

5. The directional sound control method according to claim 1, wherein:
determining the target position of the user relative to the sound panel includes:
determining a target offset direction and a target offset position of the user relative to a longitudinal centerline of the sound panel;
determining the first group of sound-emitting areas and the second group of sound-emitting areas from the plurality of sound-emitting areas of the sound panel based on the target position includes:
determining a target sound-emitting area combination from a sound-emitting matrix table corresponding to the plurality of sound-emitting areas of the sound panel based on the target offset direction and the target offset position, wherein the sound-emitting matrix table includes sound-emitting area combinations corresponding to different offset directions and offset positions, and the target sound-emitting area combination includes the first group of sound-emitting areas and the second group of sound-emitting areas.

6. The directional sound control method according to claim 1, wherein:
the plurality of sound-emitting areas include a plurality of first sound-emitting areas and a plurality of second sound-emitting areas;
the first sound-emitting areas and the second sound-emitting areas have different widths; and
the first group of sound-emitting areas and the second group of sound-emitting areas each include a same number of first sound-emitting areas and a same number of second sound-emitting areas.

7. The directional sound control method according to claim 6,
wherein a width of a second sound-emitting area of the plurality of second sound-emitting areas is a target multiple of a width of a first sound-emitting area of the plurality of first sound-emitting areas, and the target multiple is a value greater than 1;
the method further comprising:
obtaining a head reference width of the user of the sound panel;
determining the width of the first sound-emitting area in the sound panel based on the head reference width and the width of the sound panel; and
determining the plurality of first sound-emitting areas and the plurality of second sound-emitting areas divided in the sound panel based on the width of the first sound-emitting area and the target multiple.

8. The directional sound control method according to claim 1, further comprising:
determining a width of each sound-emitting area of the plurality of sound-emitting areas based on a head reference width of a user of the sound panel;
determining a set number of sound-emitting areas based on the width of each sound-emitting area and a width of the sound panel; and
determining the plurality of sound-emitting areas divided in the sound panel based on the set number of sound-emitting areas.

9. A directional sound control apparatus, applied to an electronic device, comprising:
a position determination unit configured to determine a target position of a user relative to a sound panel;
a sound group determination unit configured to determine a first group of sound-emitting areas and a second group of sound-emitting areas from a plurality of sound-emitting areas of the sound panel based on the target position, wherein the sound-emitting areas are arranged longitudinally along the sound panel, the plurality of sound-emitting areas are arranged sequentially in parallel, the first group of sound-emitting areas and the second group of sound-emitting areas are located on two sides of and adjacent to the target position, each of the first group of sound-emitting areas and the second group of sound-emitting areas includes at least one sound-emitting area, a number of sound-emitting areas in the first group of sound-emitting areas and a number of sound-emitting areas in the second group of sound-emitting areas is the same, and when the target position changes, the number of sound-emitting areas determined in the first group of sound-emitting areas changes; and
a directional sound control unit configured to control sound-emitting areas in the first group of sound-emitting areas and sound-emitting areas in the second group of sound-emitting areas to output an audio signal.

10. The directional sound control apparatus according to claim 9, wherein:
the plurality of sound-emitting areas of the sound panel include a plurality of first sound-emitting areas and a plurality of second sound-emitting areas, the first sound-emitting areas and the second sound-emitting areas having different widths;
the first group of sound-emitting areas and the second group of sound-emitting areas determined by the sound group determination unit each include a same number of first sound-emitting areas and a same number of second sound-emitting areas.

11. An electronic device comprising:
one or more processors; and
one or more memories storing computer instructions that, when executed by the one or more processors, cause the one or more processors to:
determine a target position of a user relative to a sound panel;
based on the target position, determine a first group of sound-emitting areas and a second group of sound-emitting areas from a plurality of sound-emitting areas of the sound panel, wherein the sound-emitting areas are arranged longitudinally along the sound panel, the plurality of sound-emitting areas are arranged sequentially in parallel, the first group of sound-emitting areas and the second group of sound-emitting areas are located on two sides of and adjacent to the target position, each of the first group of sound-emitting areas and the second group of sound-emitting areas includes at least one sound-emitting area, the first group of sound-emitting areas and the second group of sound-emitting areas include same number of sound-emitting areas, and the number of sound-emitting areas identified in the first group of sound-emitting areas changes when the target position changes; and
control sound-emitting areas in the first group of sound-emitting areas and sound-emitting areas in the second group of sound-emitting areas to output an audio signal.

12. The electronic device according to claim 11, wherein the one or more processors are further configured to:
determine a center sound-emitting area corresponding to a user from the plurality of sound-emitting areas of the sound panel based on the target position; and
according to a target number and a respective number of sound-emitting areas on the two sides of the center sound-emitting area, determine the first group of sound-emitting areas and the second group of sound-emitting areas located on the two sides of and adjacent to the center sound-emitting area, wherein the number of sound-emitting areas in the first group of sound-emitting areas and the number of sound-emitting areas in the second group of sound-emitting areas do not exceed the target number, and the target number is a preset maximum number of sound-emitting areas in a sound-emitting area group.

13. The electronic device according to claim 12, wherein the one or more processors are further configured to:
in response to more than or equal to the target number of other sound-emitting areas being provided on each of the two sides of the center sound-emitting area, determine the first group of sound-emitting areas and the second group of sound-emitting areas located on the two sides of and adjacent to the center sound-emitting area, wherein the first group of sound-emitting areas and the second group of sound-emitting areas each include the target number of sound-emitting areas; and
in response to a total number of other sound-emitting areas on one side of the center sound-emitting area being more than or equal to 1 but less than the target number, determine the first group of sound-emitting areas and the second group of sound-emitting areas located on the two sides of and adjacent to the center sound-emitting area based on the total number, wherein the first group of sound-emitting areas and the second group of sound-emitting areas each include the total number of sound-emitting areas.

14. The electronic device according to claim 11, wherein:
the sound panel is arranged on an upper layer of a display unit of the electronic device, and the display unit is rotatable around a rotation member; and
the one or more processors are further configured to:
determine the target position of the user relative to the display unit in response to the display unit being in a target posture, wherein when the display unit is in the target posture, a shorter side of the display unit is parallel to an image display direction of the display unit displaying an image.

15. The electronic device according to claim 11, wherein the one or more processors are further configured to:
determine a target offset direction and a target offset position of the user relative to a longitudinal centerline of the sound panel; and
determine a target sound-emitting area combination from a sound-emitting matrix table corresponding to the plurality of sound-emitting areas of the sound panel based on the target offset direction and the target offset position, wherein the sound-emitting matrix table includes sound-emitting area combinations corresponding to different offset directions and offset positions, and the target sound-emitting area combination includes the first group of sound-emitting areas and the second group of sound-emitting areas.

16. The electronic device according to claim 11, wherein:
the plurality of sound-emitting areas include a plurality of first sound-emitting areas and a plurality of second sound-emitting areas;
the first sound-emitting areas and the second sound-emitting areas have different widths; and
the first group of sound-emitting areas and the second group of sound-emitting areas each include a same number of first sound-emitting areas and a same number of second sound-emitting areas.

17. The electronic device according to claim 16, wherein:
a width of a second sound-emitting area of the plurality of second sound-emitting areas is a target multiple of a width of a first sound-emitting area of the plurality of first sound-emitting areas, and the target multiple is a value greater than 1; and
the one or more processors are further configured to:
obtain a head reference width of the user of the sound panel;
determine the width of the first sound-emitting area in the sound panel based on the head reference width and the width of the sound panel; and
determine the plurality of first sound-emitting areas and the plurality of second sound-emitting areas divided in the sound panel based on the width of the first sound-emitting area and the target multiple.

18. The electronic device according to claim 11, wherein the one or more processors are further configured to:
determine a width of each sound-emitting area of the plurality of sound-emitting areas based on a head reference width of a user of the sound panel;
determine a set number of sound-emitting areas based on the width of each sound-emitting area and a width of the sound panel; and
determine the plurality of sound-emitting areas divided in the sound panel based on the set number of sound-emitting areas.
